(19) United States
(12) Patent Application Publication
(10) Pub. No.: US 2018/0221929 A1
(43) Pub. Date: Aug. 9, 2018

(54) INTELLIGENT COIL LEVELING VALIDATING SYSTEM AND VALIDATING METHOD THEREOF

(71) Applicant: NATIONAL TSING HUA UNIVERSITY, HSINCHU (TW)

(72) Inventors: Jen-Yuan CHANG, HSINCHU (TW); Brian CHEN, HSINCHU (TW); Sung-Yu TSAI, HSINCHU (TW)

(21) Appl. No.: 15/610,643

(22) Filed: Jun. 1, 2017

(30) Foreign Application Priority Data
Feb. 8, 2017 (TW) 106104146

(51) Int. Cl. B21D 1/02; B21C 51/00; G01B 21/20

(52) U.S. Cl. CPC B21D 1/02; G01B 21/20; B21C 51/00

(57) ABSTRACT

An intelligent coil leveling validating system includes a platform, a coil inputting device, a leveling device, a curvature measuring device and a processor. The coil inputting device is disposed on the platform. The coil inputting device includes an inputting end and the coil. The coil is movably connected to the inputting end. The leveling device is disposed on the platform and configured to move the coil. The leveling device has a practical downward moving distance. The coil is pressed and rolled by the leveling device, and then has a second curvature. The curvature measuring device detects the coil and obtains the second curvature. The processor generates a simulated downward moving distance of the leveling device according to a response surface method. The processor receives the second curvature and performs feedback control to adjust the practical downward moving distance close to the simulated downward moving distance.

### RELATED APPLICATIONS

This application claims priority to Taiwan Application Serial Number 106104146, filed Feb. 8, 2017, which is herein incorporated by reference.

### BACKGROUND

### Technical Field

The present disclosure relates to a coil leveling validating system and a validating method thereof. More particularly, the present disclosure relates to an intelligent coil leveling validating system and a validating method thereof with real-time feedback control and fault detection.

### Description of Related Art

The installations for the production and treatment of steel strip, the strip is usually delivered to the installation in coils for further processing or treatment. It is then received in an entry section and unwound, and is threaded into the installation for treatment in this way. The metal coil is conveyed into the installation by the unwinding reels. To do this, the bent leading end of the coil must be leveled to allow the coil to be threaded into the entry section of the installation.

The quality of the strip treatment and the quality of the strip as such depend on how successful the method is at bringing the initially coiled strip into a flat state. Leveling machines for accomplishing this are known which bring the initially uneven coil into a flat state by applying force to the coil with a number of leveling rolls. Roller leveling is a bending method in which certain tools, called leveling rollers, bend the material to be leveled back and forth. In these leveling machines, the material to be leveled is passed between two opposing rows of leveling rollers, which are offset from each other. The upper and lower rows of leveling rollers are offset from each other in such a way that the rollers of one row nest in the intermediate spaces between the opposing rollers.

In order to correct the flatness deviation of the metal coil in the leveling machines, a conventional technique is provided for controlling positions of the leveling rollers. This method will find suitable positions of the leveling rollers according to the measured value of the flatness deviation of the metal coil. In other words, a function of the shape of the metal coil is used, that is, its relevant actual coefficient, and then the target coefficient is determined from the actual coefficient. Finally, the target coefficient is converted into a leveling roller of the positional control. However, the conventional technique is constructed in a complicated manner and is prone to failure when the leveling machine is used for a long time. It is not easy to detect the failure until a serious problem occurring on the metal coil after leveling, thereby increasing the increasing the cost and production time, and seriously affecting the quality of the product. Therefore, a coil leveling validating system and a validating method thereof having the features of real-time control, automatic fault diagnosis and instantly monitoring technique combined with a cloud network are commercially desirable.

### SUMMARY

According to one aspect of the present disclosure, an intelligent coil leveling validating system for leveling and validating a coil having a thickness, a width and a first curvature before leveling includes a platform, a coil inputting device, a leveling device, a curvature measuring device and a processor. The coil inputting device is disposed on the platform. The coil inputting device includes an inputting end and the coil. The coil is movably connected to the inputting end. There is a first distance between the leveling device and the inputting end. The leveling device includes a first leveling module and a second leveling module. The first leveling module is disposed on the platform and configured to move the coil. The second leveling module is corresponding to the first leveling module and movably positioned on the platform. The second leveling module has a practical downward moving distance. The coil is pressed and rolled by the first leveling module and the second leveling module. The coil is moved between the first leveling module and the second leveling module, and the coil has a second curvature. The curvature measuring device is disposed on the platform. There is a second distance between the curvature measuring device and the inputting end. The second distance is greater than the first distance. The curvature measuring device detects the coil and obtains the second curvature. The processor is signally connected to the leveling device and the curvature measuring device. The processor calculates the thickness, the width and the first curvature to generate a simulated downward moving distance of the second leveling module according to a response surface method. The processor receives the second curvature and performs feedback control to adjust the practical downward moving distance close to the simulated downward moving distance.

According to another aspect of the present disclosure, a validating method of an intelligent coil leveling validating system for leveling and validating a coil includes a coil deformation analyzing step, an intelligent leveling step and an accuracy validating step. The coil deformation analyzing step is for analyzing a thickness, a width and a first curvature of the coil before leveling. The intelligent leveling step includes a functional arithmetic processing step and a coil leveling step. The functional arithmetic processing step is for applying a processor to calculate the thickness, the width and the first curvature according to a response surface method to generate a simulated downward moving distance of a second leveling module of a leveling device. The coil leveling step is for applying the leveling device to press and roll the coil according to the simulated downward moving distance so as to deform the coil and generate a second curvature of the coil. The accuracy validating step is for applying a curvature measuring device to detect the coil and obtain the second curvature. The steps of the validating method are carried out in order of the coil deformation analyzing step, the intelligent leveling step and the accuracy validating step. The accuracy validating step is feedback connected to the intelligent leveling step, and the processor receives the second curvature and performs feedback control to adjust a practical downward moving distance of the second leveling module close to the simulated downward moving distance.

### BRIEF DESCRIPTION OF THE DRAWINGS

The present disclosure can be more fully understood by reading the following detailed description of the embodiment, with reference made to the accompanying drawings as follows:

FIG. 1A shows a schematic view of an intelligent coil leveling validating system according to one embodiment of the present disclosure;

FIG. 1B shows a block diagram of the intelligent coil leveling validating system of FIG. 1A;

FIG. 2 shows a partial side view of the intelligent coil leveling validating system of FIG. 1A;

FIG. 3 shows a schematic view of the intelligent coil leveling validating system associated with a cloud network of FIG. 1A;

FIG. 4 shows a schematic view of a moving roller of the intelligent coil leveling validating system of FIG. 1A;

FIG. 5A shows a graph of a deformation percentage and a downward moving distance of the intelligent coil leveling validating system of FIG. 1A;

FIG. 5B shows a graph of a sheet metal cross section and a stress at a position P1 of FIG. 2;

FIG. 5C shows a graph of a sheet metal cross section and a stress at a position P2 of FIG. 2;

FIG. 5D shows a graph of a sheet metal cross section and a stress at a position P3 of FIG. 2;

FIG. 5E shows a graph of a sheet metal cross section and a stress at a position P4 of FIG. 2;

FIG. 5F shows a graph of a sheet metal cross section and a stress at a position P5 of FIG. 2;

FIG. 5G shows a graph of a sheet metal cross section and a stress at a position P6 of FIG. 2;

FIG. 5H shows a schematic view of the coil under pressure of FIG. 2;

FIG. 6A shows a flow chart of an intelligent coil leveling validating method according to one embodiment of the present disclosure;

FIG. 6B shows a flow chart of a coil deformation analyzing step of the intelligent coil leveling validating method of FIG. 6A;

FIG. 6C shows a flow chart of an intelligent leveling step of the intelligent coil leveling validating method of FIG. 6A;

FIG. 6D shows a flow chart of an accuracy validating step of the intelligent coil leveling validating method of FIG. 6A; and

FIG. 7 shows a flow chart of an intelligent coil leveling validating method according to another embodiment of the present disclosure;

### DETAILED DESCRIPTION

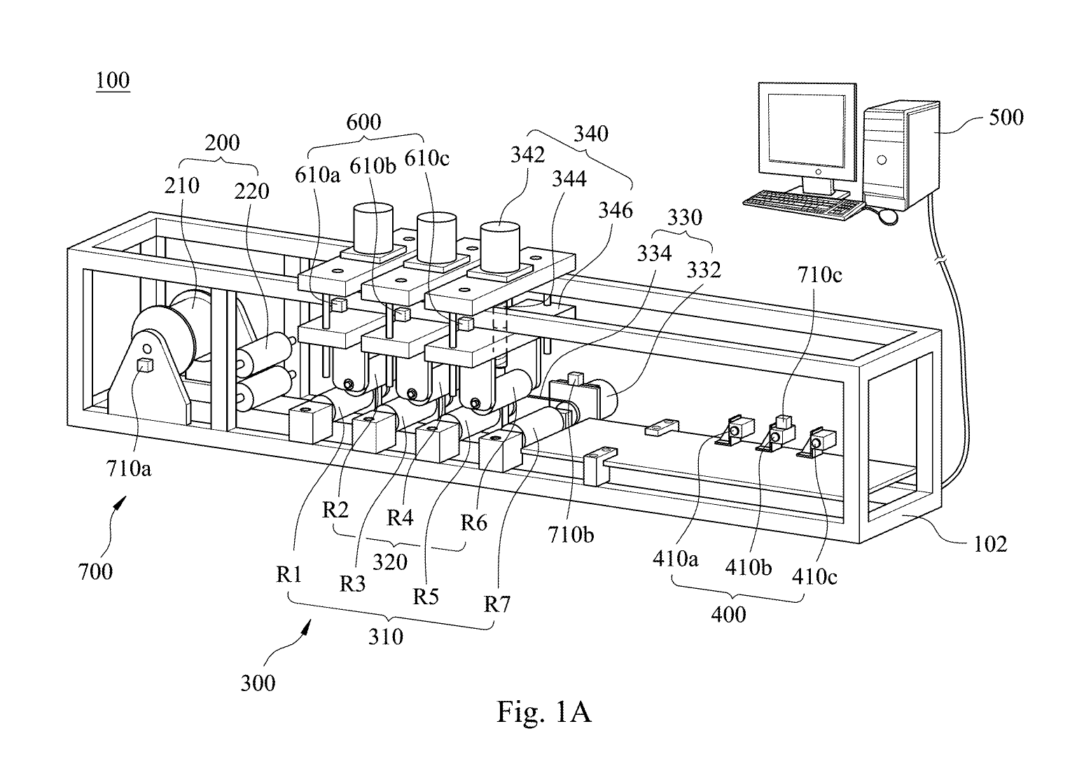

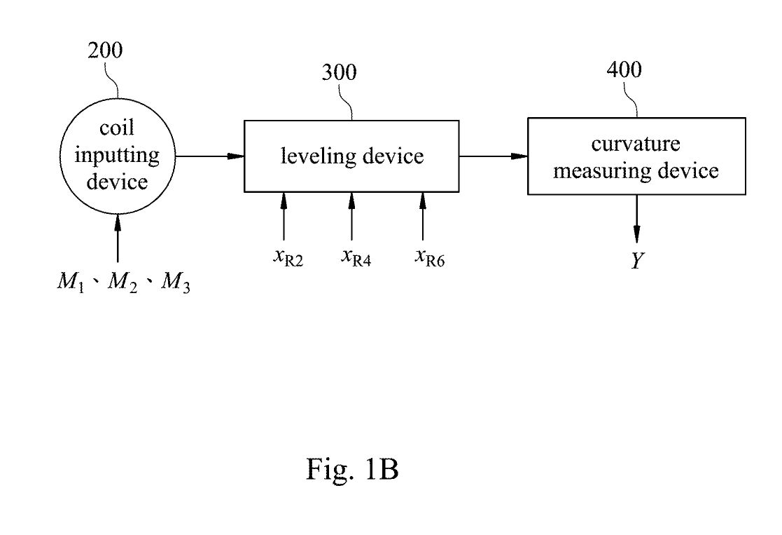

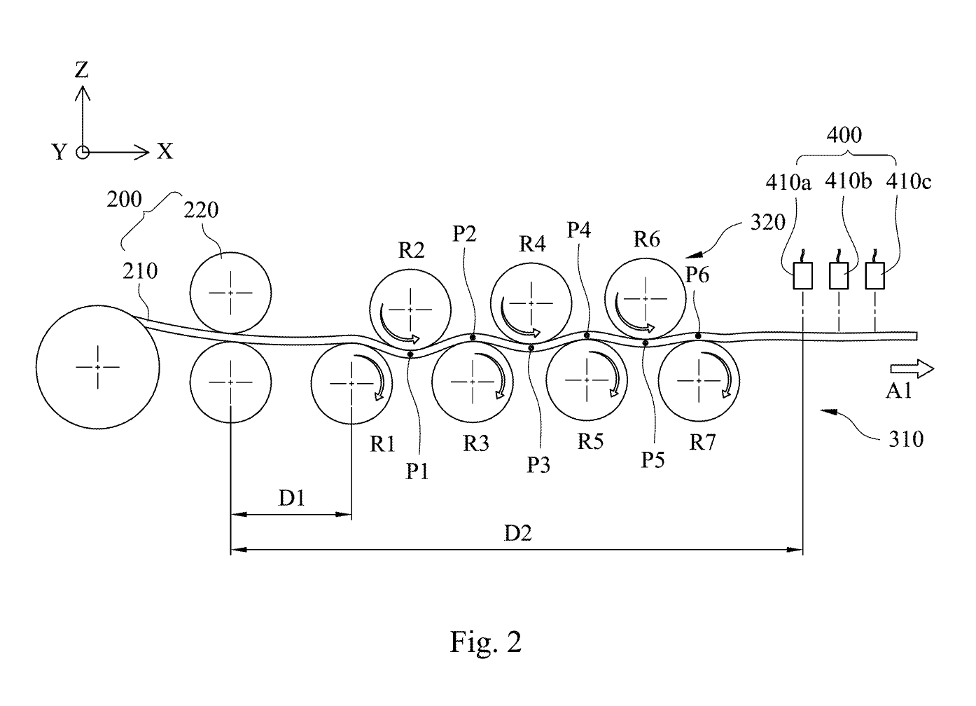

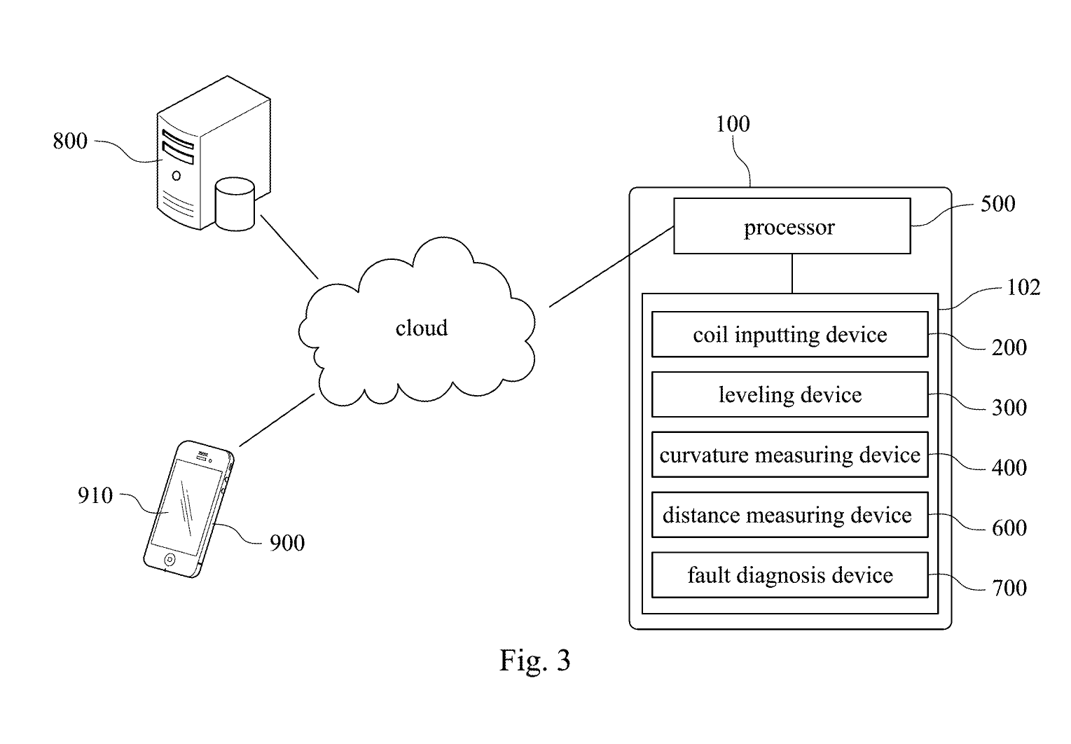

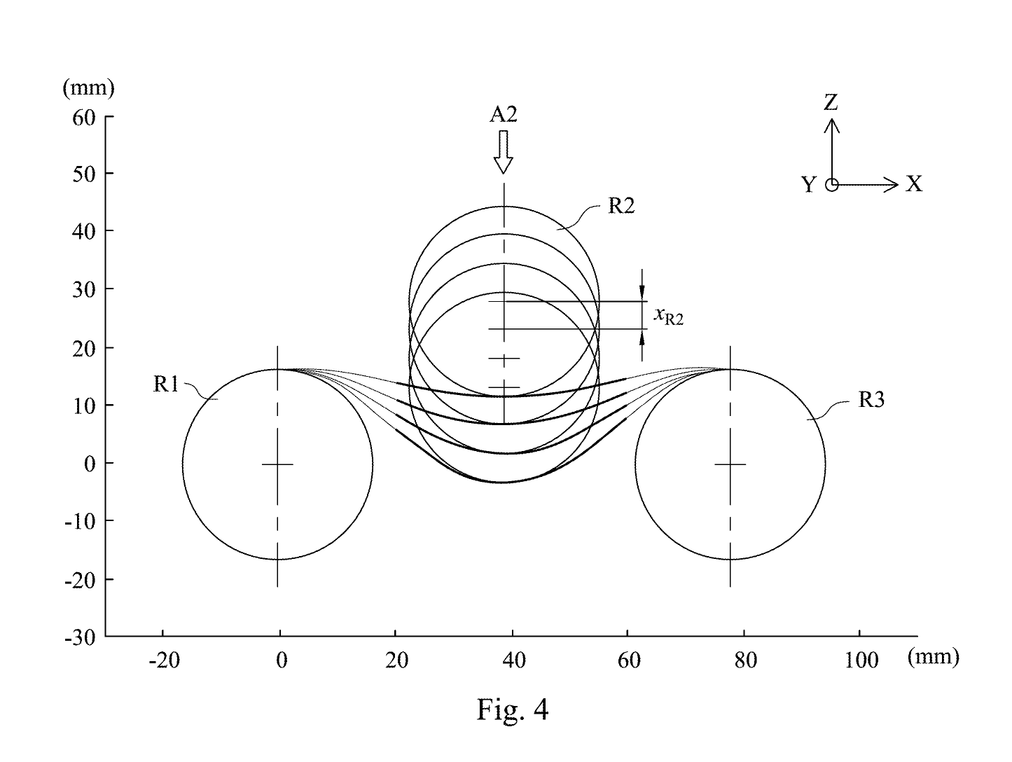

FIG. 1A shows a schematic view of an intelligent coil leveling validating system 100 according to one embodiment of the present disclosure; FIG. 1B shows a block diagram of the intelligent coil leveling validating system 100 of FIG. 1A; FIG. 2 shows a partial side view of the intelligent coil leveling validating system 100 of FIG. 1A; FIG. 3 shows a schematic view of the intelligent coil leveling validating system 100 associated with a cloud network of FIG. 1A; and FIG. 4 shows a schematic view of a moving roller R2 of the intelligent coil leveling validating system of FIG. 1A. In FIGS. 1A-3, the intelligent coil leveling validating system 100 for leveling and validating a coil 210 includes a platform 102, a coil inputting device 200, a leveling device 300, a curvature measuring device 400, a processor 500, a distance measuring device 600, a fault diagnosis device 700, a network server 800 and a user terminal device 900.

The platform 102 is an elongated conveyor belt which is configured to dispose the coil inputting device 200, the leveling device 300, the curvature measuring device 400, the distance measuring device 600 and the fault diagnosis device 700, so that the stable and smooth operation of these devices can be obtained.

The coil inputting device 200 is disposed on the platform 102. The coil inputting device 200 includes the coil 210 and an inputting end 220. The coil 210 is made of a metal material, and has a thickness M₁, a width M₂ and a first curvature M₃ before leveling. The coil 210 is movably connected to the inputting end 220. The inputting end 220 has two clamping rollers. A gap formed between the two clamping rollers is corresponding to the thickness M₁ of the coil 210.

The leveling device 300 is disposed on the platform 102. There is a first distance D1 between the leveling device 300 and the inputting end 220 of the coil inputting device 200. The leveling device 300 includes a first leveling module 310, a second leveling module 320, a first rotating unit 330 and a second rotating unit 340. The first leveling module 310 is disposed on the platform 102. The first leveling module 310 is configured to move the coil 210 and is located below the coil 210, i.e., the coil 210 is supported by the first leveling module 310. The first leveling module 310 includes four rollers R1, R3, R5, R7 which are equidistantly arranged on the platform 102. In addition, the second leveling module 320 is corresponding to the first leveling module 310 and movably positioned on the platform 102. The second leveling module 320 has a practical downward moving distance x. The coil 210 is pressed and rolled by the first leveling module 310 and the second leveling module 320. The coil 210 is moved between the first leveling module 310 and the second leveling module 320, and then the coil 210 has a second curvature. The second leveling module 320 includes three rollers R2, R4, R6 which are equidistantly arranged on the platform 102. The three rollers R2, R4, R6 are correspondingly interlaced with the four rollers R1, R3, R5, R7. The three rollers R2, R4, R6 have a first downward moving distance x_{R2}, a second downward moving distance x_{R4}, a third downward moving distance x_{R6}, respectively. The practical downward moving distance x is composed of the first downward moving distance x_{R2}, the second downward moving distance x_{R4} and the third downward moving distance x_{R6}, i.e., the practical downward moving distance x represents a set of the downward moving distances x_{R2}, x_{R4}, x_{R6}. Moreover, the first rotating unit 330 is disposed on the platform 102 and connected to the first leveling module 310. The first rotating unit 330 is controlled by the processor 500 to rotate the first leveling module 310 so as to move the coil 210 in an X-axis direction. In detail, the first rotating unit 330 includes a motor 332 and a belt 334 connected to the motor 332. The belt 334 is connected to the four rollers R1, R3, R5, R7. The processor 500 controls the rotation of the motor 332 to rotate the first leveling module 310 by the belt 334, thereby synchronously rotating the four rollers R1, R3, R5, R7 in the same direction. The coil 210 moved along the first leveling module 310 in a coil moving direction A1 which is parallel to the X-axis direction. Furthermore, the second rotating unit 340 is disposed on the platform 102 and connected to the second leveling module 320. The second rotating unit 340 is controlled by the processor 500 to move the second leveling module 320 in a Z-axis direction. The second rotating unit 340 includes three motors 342, three helical axes 344 and three seats 346. The three motors 342 are connected to the three helical axes 344 and rotate the three helical axes 344, respectively. The three helical axes 344 are pivotally connected to the three seats 346, respectively. The three rollers R2, R4, R6 of the second leveling module 320 are disposed on the three seats 346, respectively. Each of the three helical axes 344 rotated by the corresponding motor 342 moves the corresponding seat 346, so that the second leveling module 320 is driven to move up and down. In other words, the second leveling module 320 is moved in a downward moving direction A2 which is parallel to the Z-axis direction.

The curvature measuring device 400 is disposed on the platform 102. There is a second distance D2 between the curvature measuring device 400 and the inputting end 220. The second distance D2 is greater than the first distance D1. The curvature measuring device 400 detects the coil 210 and obtains the second curvature after leveling. In detail, the curvature measuring device 400 includes three curvature detectors 410a, 410b, 410c disposed on the platform 102 and signally connected to the processor 500. The curvature detectors 410a, 410b, 410c are spaced apart different distances from the inputting end 220. The curvature detectors 410a, 410b, 410c are configured to detect a plurality of curvatures of the coil 210 at different positions and output the curvatures to the processor 500.

The processor 500 is signally connected to the leveling device 300 and the curvature measuring device 400. The processor 500 calculates the thickness M₁, the width M₂ and the first curvature M₃ to generate a simulated downward moving distance of the second leveling module 320 according to a response surface method. The processor 500 receives the second curvature and performs feedback control to adjust the practical downward moving distance x close to the simulated downward moving distance. In addition, the response surface method has a response surface equation which is given by:

Y=f(x_{R2},x_{R4},x_{R6}|M₁,M₂,M₃)+ε (1)

Wherein Y represents a surface flatness of the coil, M₁ represents the thickness of the coil 210, M₂ represents the width of the coil 210, M₃ represents the first curvature of the coil 210, x_{R2} represents a first downward moving distance, x_{R4} represents a second downward moving distance, x_{R6} represents a third downward moving distance, and e represents an error value. Accordingly, the proposed intelligent coil leveling validating system 100 utilizes a real-time compensation to adjust the leveling device 300, thus accomplishing the automatic intelligent real-time feedback control and validation. Moreover, the optimal values of the first downward moving distance x_{R1}, the second downward moving distance x_{R4} and the third downward moving distance x_{R6} can be generated by performing the response surface equation with the thickness M₁, the width M₂ and the first curvature M₃ of the coil 210, thereby automatically optimizing machine settings and the flatness of the coil 210 and improving precision and quality of the intelligent coil leveling validating system 100.

The distance measuring device 600 is disposed on the platform 102 and signally connected to the processor 500. The distance measuring device 600 detects the practical downward moving distance x and transmits the practical downward moving distance x to the processor 500. The distance measuring device 600 includes three distance measuring modules 610a, 610b, 610c which are disposed on the platform 102 and corresponding to the three seats 346 of the second rotating unit 340, respectively. The three distance measuring modules 610a, 610b, 610c can detect the first downward moving distance x_{R2}, the second downward moving distance x_{R4} and the third downward moving distance x_{R6} of the three seats 346, respectively. For example, when the first curvature M₃ is 1982.26 mm, the first downward moving distance x_{R2}, the second downward moving distance x_{R4} and the third downward moving distance x_{R6} detected by the distance measuring modules 610a, 610b, 610c are 1.34 mm, 0.57 mm and 0.05 mm, respectively. The three curvature detectors 410a, 410b, 410c of the curvature measuring device 400 detect the coil 210 and obtain three curvatures after leveling. The three second curvatures are −0.06 mm, 0.24 mm and 0.37 mm, respectively, and can be calculated to obtain the second curvature which is 25600.06 mm. Therefore, the curvature measuring device 400 cooperated with the distance measuring device 600 can accurately measure a moving condition and a change in the flatness of the coil 210. Not only for measurement and control, the data (e.g., machine settings, curvatures or downward moving distances) may be collected to a cloud and used to create new compensated manufacturing parameters depending on variety of materials, environment conditions and machine settings in real time.

The fault diagnosis device 700 is disposed on the platform 102 and signally connected to the coil inputting device 200, the leveling device 300, the curvature measuring device 400, the processor 500 and the distance measuring device 600. The fault diagnosis device 700 detects the coil inputting device 200, the leveling device 300, the curvature measuring device 400, the distance measuring device 600 and the platform 102 to generate a diagnostic message. The diagnostic message is transmitted to the processor 500 by the fault diagnosis device 700. In addition, the fault diagnosis device 700 includes three fault detectors 710a, 710b, 710c disposed on the coil inputting device 200, the leveling device 300 and the curvature measuring device 400, respectively. The fault detectors 710a, 710b, 710c are located at different positions relative to each other. Each of the fault detectors 710a, 710b, 710c is configured to detect whether or not the coil inputting device 200, the leveling device 300 or the curvature measuring device 400 is normal and generate a sensed message. The sensed message is transmitted to the processor 500, and the diagnostic message is composed of the sensed messages of the fault detectors 710a, 710b, 710c. In addition, the fault diagnosis device 700 includes a variety of sensors, such as an oil sensor, an angular sensor or a displacement sensor. These sensors can be disposed at specific positions to sense corresponding parameters. The oil sensor can be used to sense whether the lubricant is enough or too much. The angular sensor can be used to sense whether the releasing angle is correct or not. The displacement sensor can be used to sense the displacement conditions of the coil 210, such as material moved in a snake-like manner, material slippage, improper feeding, material transmission anomaly or material unflatness. Table 1 lists the fault events and the number of occurrences of the intelligent coil leveling validating system 100. The data in Table 1 are measured by the fault diagnosis device 700. Through a precision servoing and intelligent sensor network embedded in the proposed intelligent coil leveling validating system 100, key parameters and information of the manufacturing line can be real-time monitored via the cloud network, analyzed, and feedback controlled along with machine health indexes so as to ensure all machine settings and parameters meeting the target value and manufacturing quality.

TABLE 1

| | | Occurrence | Occurrence |
|---|---|---|---|
| Code | Events | in 1^{st} year | in 2^{nd} year |
| H1 | Lubricant is too much | 2 | 2 |
| H2 | Brake failure | 2 | 2 |
| H3 | Throttle is set improperly | 2 | 0.5 |
| H4 | Releasing angle is set improperly | 2 | 1 |
| H5 | Servo motor driving parameter is set | 2 | 0.01 |
| | improperly | | |
| H6 | 1^{st} moving distance is set improperly | 2 | 0.1 |
| H7 | 2^{nd} moving distance is set improperly | 4 | 0.1 |
| H8 | Material moved in a snake-like | 6.51 | 3.81 |
| | manner | | |
| H9 | Material slippage | 4 | 3 |
| H10 | Improper feeding | 10 | 6.21 |
| H11 | Feeding roller is not clean | 3 | 2.4 |
| H12 | Gear or roller is not clean | 6 | 4.8 |
| H13 | Material transmission anomaly | 22.88 | 14.29 |
| H14 | Material unflatness | 7 | 0.7 |

The network server 800 is signally connected to the processor 500 via the cloud. The network server 800 accesses the thickness M₁, the width M₂, the first curvature M₃, the simulated downward moving distance and the second curvature. The types of the signal links of the network server 800 may include ADSL, Ethernet, Optical fiber, Bluetooth, 3G, 4G, 5G, WiFi or the like. Accordingly, the present disclosure can analyze the condition parameters of the intelligent coil leveling validating system 100 by the network server 800 combined with real-time continuous cloud monitoring and immediate visual information according to different customer requirements and specifications, so that a user can easily know whether there is any abnormality in the intelligent coil leveling validating system 100, and obtain quality and production efficiency of the coil 210 in real time.

The user terminal device 900 is signally connected to the network server 800 and the processor 500 through clouds. The user terminal device 900 has a user interface 910. The user interface 910 displays the thickness M₁, the width M₂, the first curvature M₃, the surface flatness Y, the simulated downward moving distance and the second curvature. The user interface 910 may be a mobile device, such as a mobile phone. An application program (APP) can be installed in the mobile phone to check the condition parameters of the intelligent coil leveling validating system 100 in real time.

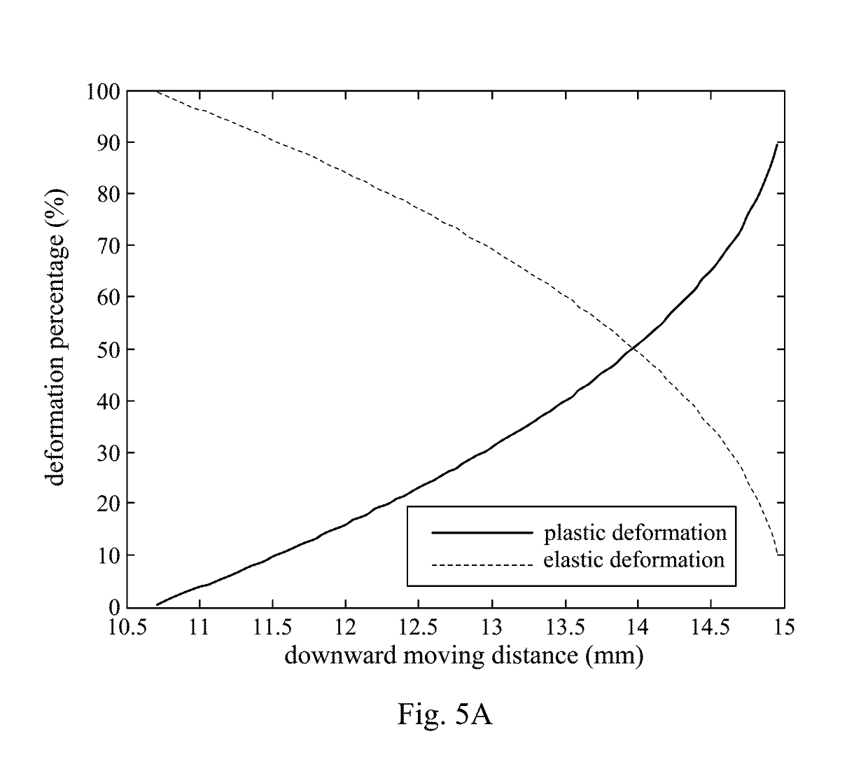

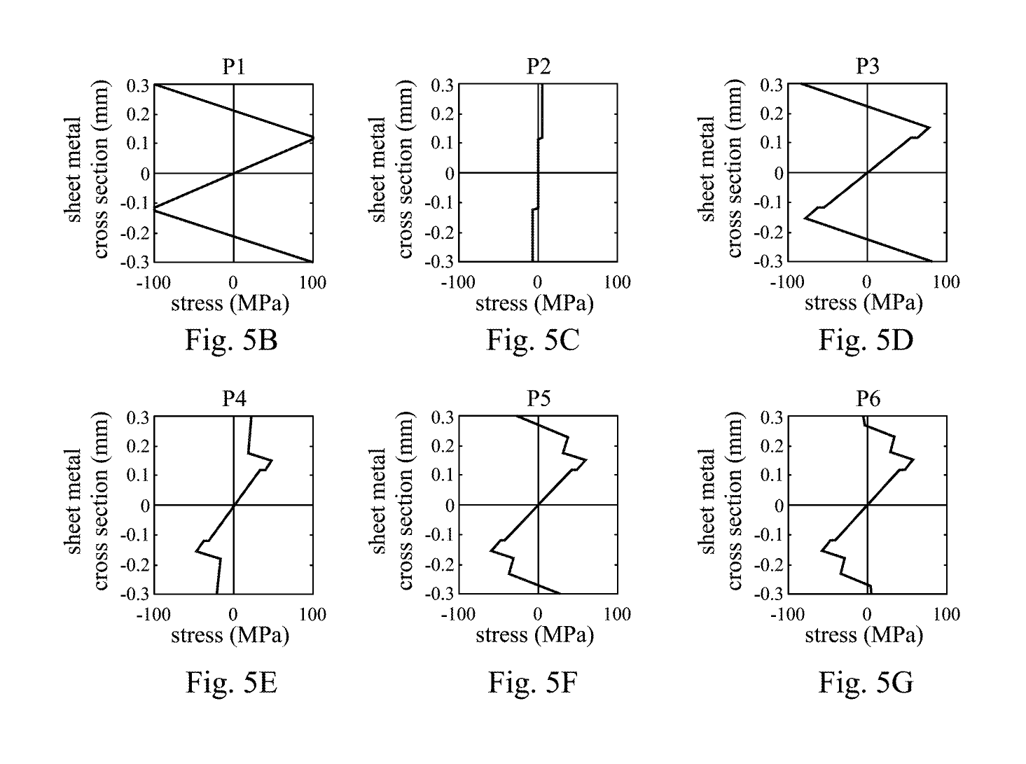

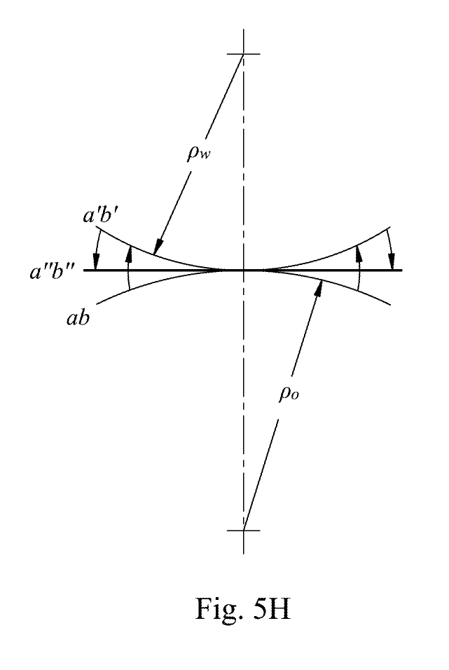

FIG. 5A shows a graph of a deformation percentage and a downward moving distance of the intelligent coil leveling validating system 100 of FIG. 1A; FIG. 5B shows a graph of a sheet metal cross section and a stress at a position P1 of FIG. 2; FIG. 5C shows a graph of a sheet metal cross section and a stress at a position P2 of FIG. 2; FIG. 5D shows a graph of a sheet metal cross section and a stress at a position P3 of FIG. 2; FIG. 5E shows a graph of a sheet metal cross section and a stress at a position P4 of FIG. 2; FIG. 5F shows a graph of a sheet metal cross section and a stress at a position P5 of FIG. 2; FIG. 5G shows a graph of a sheet metal cross section and a stress at a position P6 of FIG. 2; and FIG. 5H shows a schematic view of the coil 210 under pressure of FIG. 2. In FIGS. 2 and 5A-5H, the plastic deformation and the elastic deformation are produced in the coil 210 to cancel an internal residual stress during the leveling process. The internal residual stress in the coil 210 is caused by the plastic deformation when the coil 210 is bent, so that the partial fibers in the coil 210 cannot be linearly restored to the original state. Accordingly, the proposed intelligent coil leveling validating system 100 is used to remove the internal residual stress in the coil 210 and reduce the plastic deformation by effectively leveling the coil 210. When the coil 210 is bent at a first position P1 during the leveling process, the residual stress is compensated by a deforming stress because of the residual stress in a direction inverse to a direction of the deforming stress. When the coil 210 is bent at a second position P2 during the leveling process, the residual stress is further compensated by another deforming stress in a direction inverse to the direction of the deforming stress at the first position P1 due to different positions of the rollers R2 and R3 so as to further reduce the plastic deformation of the coil 210. The cycle will continue until the coil 210 has been bent at a final position P6 (i.e., the coil 210 is passed through the last roller R7). Moreover, in order to reduce the plastic deformation of the coil 210, the coil 210 have to be passed through the rollers R1, R2, R3, R4, R5, R6 and R7 for conducting a small deformation and a large deformation. The principle of the downward moving distance of the small deformation is that a press deflection is equal to an elastic deflection. In other words, the small deformation on the coil 210 should be able to cancel the plastic deformation of the coil 210 during the leveling process, as shown in FIG. 5H. The curve ab represents an original bent state of the coil 210. ρ₀ is a curvature radius of the curve ab. ρ_{w} is a curvature radius of the curve a′b′. The coil 210 is pressed by the second leveling module 320 to form the curve a′b′ during the leveling process. After pressing, the coil 210 is leveled back from the curve a′b′ to the curve a″b″, thus achieving the effect of straightening and leveling. In addition, the large deformation of the coil 210 is performed by the use of an upper and lower series of rolls R1, R2, R3, R4, R5, R6, R7 arranged in staggered relation, as shown in FIG. 2. The principle of the downward moving distance of the large deformation is that the rolls R1, R2, R3, R4, R5, R6, R7 must be disposed according to the coil 210 having a linear smoothing deformation. The linear smoothing deformation can avoid the plastic deformation and the unnecessary residual stress of the coil 210 due to excessive leveling operations. Therefore, in order to rapidly remove the residual stress from the coil 210, the first downward moving distance x_{R2} is set to be greater than the second downward moving distance x_{R4}, and the second downward moving distance x_{R4} is set to be greater than the third downward moving distance x_{R6}. The upper and lower series of rolls R1, R2, R3, R4, R5, R6, R7 are arranged in staggered relation so as to level the coil 210 to generate a linear smoothing deformation, i.e., the amplitude of the deformation of the coil 210 is linearly decreased relative to the series of rolls R1, R2, R3, R4, R5, R6, R7. Such structure can be employed to gradually recover the elastic deformation relative to the reduction of the bending. The residual stress of the coil 210 produced by bending may be gradually canceled to zero so as to achieve the effect of straightening and leveling.

The intelligent coil leveling validating system 100 is integrated with a cyber-physical system (CPS), digital experience information, Internet of Things (IoT) and big data to communicate with the coil inputting device 200, the leveling device 300, the curvature measuring device 400, the processor 500, the distance measuring device 600, the fault diagnosis device 700, the network server 800 and the user terminal device 900. Furthermore, the intelligent coil leveling validating system 100 utilizes a real-time compensation to realize the optimal leveling process via the automatic intelligent real-time feedback control and validation. In order to achieve the intelligent feeding and leveling, the CPS is configured to perform the integration of the coil inputting device 200 and the leveling device 300, and apply optimal positions of the sensors and devices of the intelligent coil leveling validating system 100. The physical quantities measured by the sensors can be analyzed by the IoT via the machine, the manufacturing line and the cloud network, and then processed by a deep learning model according to big data, so that the intelligent manufacturing technique can be performed on the manufacturing line of the intelligent coil leveling validating system 100.

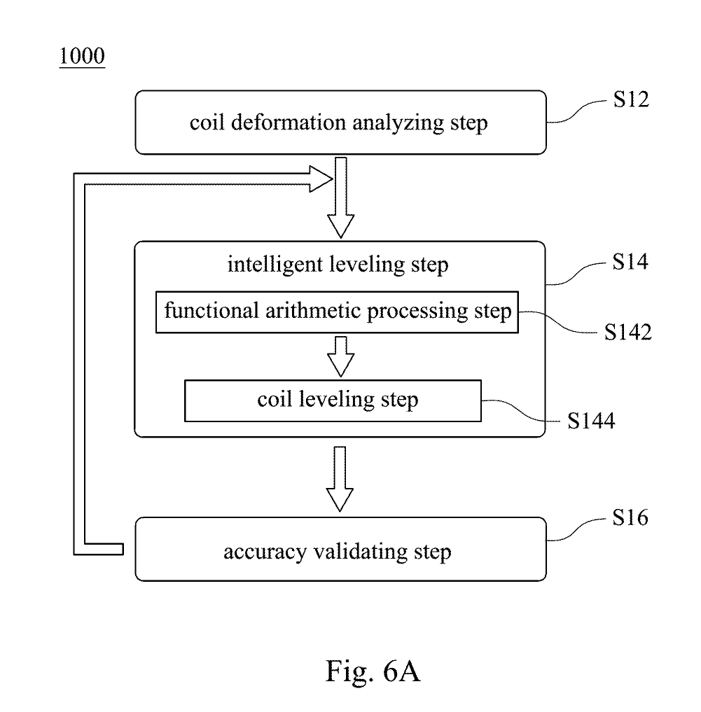

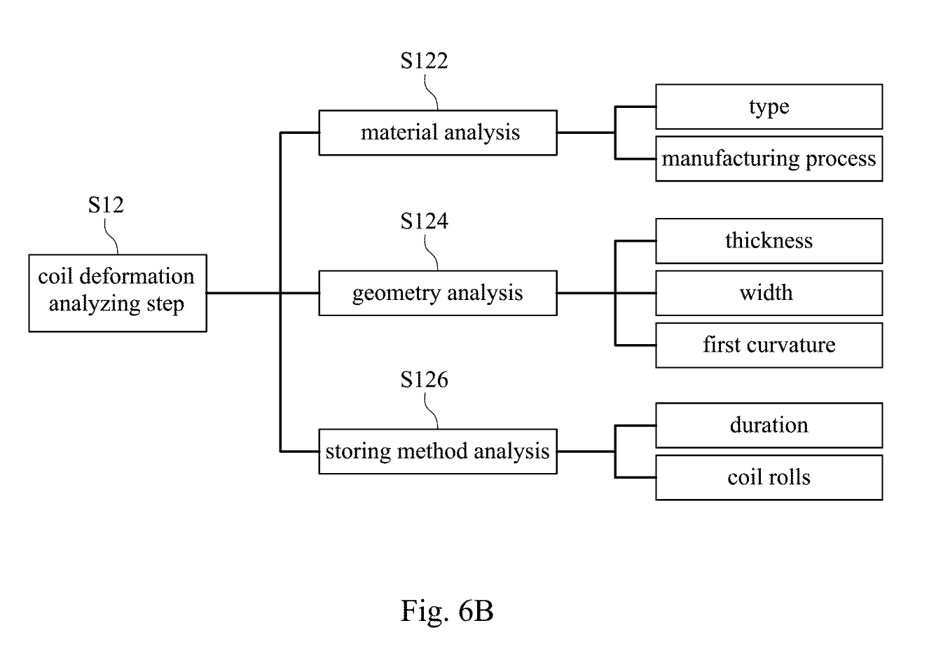

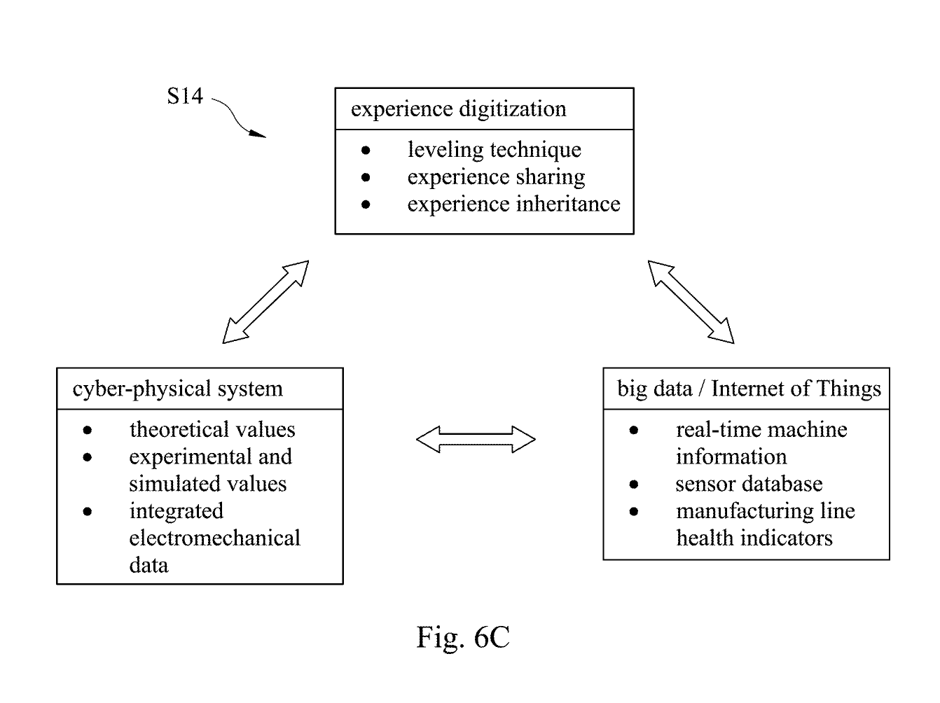

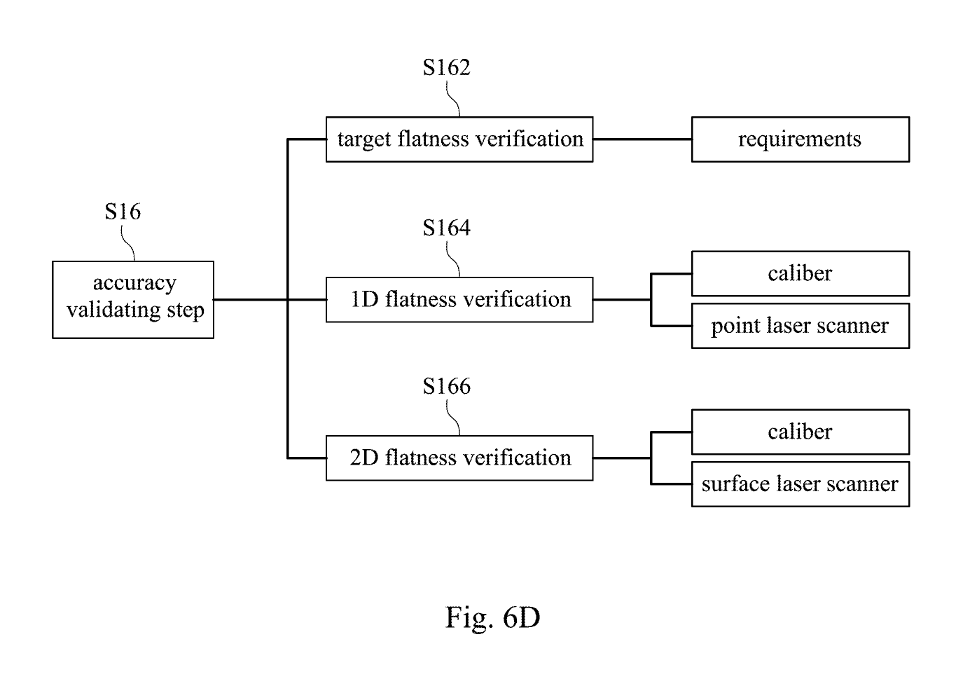

FIG. 6A shows a flow chart of an intelligent coil leveling validating method 1000 according to one embodiment of the present disclosure; FIG. 6B shows a flow chart of a coil deformation analyzing step S12 of the intelligent coil leveling validating method 1000 of FIG. 6A; FIG. 6C shows a flow chart of an intelligent leveling step S14 of the intelligent coil leveling validating method 1000 of FIG. 6A; and FIG. 6D shows a flow chart of an accuracy validating step S16 of the intelligent coil leveling validating method 1000 of FIG. 6A. In FIGS. 1A and 6A-6D, the intelligent coil leveling validating method 1000 is used to level and validate a coil 210 having a thickness M₁, a width M₂ and a first curvature M₃ before leveling. The intelligent coil leveling validating method 1000 includes the coil deformation analyzing step S12, the intelligent leveling step S14 and the accuracy validating step S16.

The steps of the intelligent coil leveling validating method 1000 are carried out in order of the coil deformation analyzing step S12, the intelligent leveling step S14 and the accuracy validating step S16. The accuracy validating step S16 is feedback connected to the intelligent leveling step S14. The coil deformation analyzing step S12 is for analyzing the thickness M₁, the width M₂ and the first curvature M₃ of the coil 210 before leveling. Moreover, the coil deformation analyzing step S12 includes a material analysis S122, a geometry analysis S124 and a storing method analysis S126. The material analysis S122 is for analyzing a material type and a manufacturing process of the coil 210. The geometry analysis S124 is for analyzing the thickness the width M₂ and the first curvature M₃ of the coil 210. The storing method analysis S126 is for analyzing a duration of storing the coil 210 and a form of coil rolls. The deformation analyzing information of the coil 210 can be used as a basis of judgment in the processor 500 to improve the leveling effect.

The intelligent leveling step S14 includes a functional arithmetic processing step S142 and a coil leveling step S144. The functional arithmetic processing step S142 is provided for applying the processor 500 to calculate the thickness M₁, the width M₂ and the first curvature M₃ according to a response surface method to generate a simulated downward moving distance of a second leveling module 320 of a leveling device 300. In addition, the coil leveling step S144 is provided for applying the leveling device 300 to press and roll the coil 210 according to the simulated downward moving distance so as to deform the coil 210 and generate a second curvature of the coil 210. Thus, the coil leveling step S144 is for performing the optimal leveling process based on an integrated control of the CPS, digital experience information, IoT and big data, as shown in FIG. 6G.

The accuracy validating step S16 is provided for applying a curvature measuring device 400 to detect the coil 210 and obtain the second curvature. The second curvature is transmitted from the curvature measuring device 400 to the processor 500. The accuracy validating step S16 is feedback connected to the intelligent leveling step S14. The processor receives the second curvature and performs feedback control to adjust a practical downward moving distance x of the second leveling module 320 close to the simulated downward moving distance. In detail, the accuracy validating step S16 includes a target flatness verification S162, a 1D flatness verification S164 and a 2D flatness verification S166. The target flatness verification S162 is for applying the curvature measuring device 400 to verify whether the flatness of the coil 210 meets the desired requirements. The 1D flatness verification S164 is for applying the curvature measuring device 400 to verify the results of a caliber and a point laser scanner. The 2D flatness verification S166 is for applying the curvature measuring device 400 to verify the results of plural calibers and a surface laser scanner. Hence, in the accuracy validating step S16, the curvature measuring device 400 is configured to measure and analyze the coil 210 in real time, and then generate new compensated manufacturing parameters to feedback control the leveling device 300 for optimal leveling. In addition, the proposed method of the present disclosure can generate the optimal values of the first downward moving distance x_{R2}, the second downward moving distance x_{R4} and the third downward moving distance x_{R6} by performing the response surface equation with the thickness M₁, the width M₂ and the first curvature M₃ of the coil 210, so that it is very suitable for the requirement of automatic intelligent production and measurement.

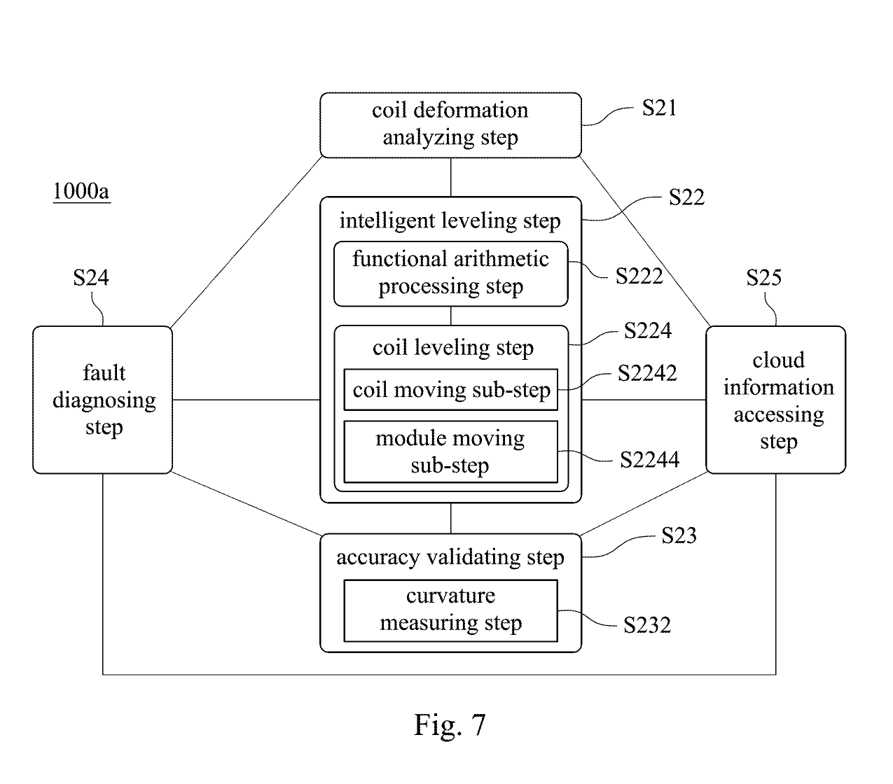

FIG. 7 shows a flow chart of an intelligent coil leveling validating method 1000a according to another embodiment of the present disclosure. The intelligent coil leveling validating method 1000a includes a coil deformation analyzing step S21, an intelligent leveling step S22, an accuracy validating step S23, a fault diagnosing step S24 and a cloud information accessing step S25.

In FIG. 7, the detail of the coil deformation analyzing step S21 is the same as the embodiments of FIG. 6B, and will not be described again herein. The intelligent leveling step S22 includes a functional arithmetic processing step S222 and a coil leveling step S224. The functional arithmetic processing step S222 is provided for applying the processor 500 to calculate the thickness M₁, the width M₂ and the first curvature M₃ according to a response surface method to generate a simulated downward moving distance of a second leveling module 320 of a leveling device 300. The coil leveling step S224 is provided for applying the leveling device 300 to press and roll the coil 210 according to the simulated downward moving distance so as to deform the coil 210 and generate a second curvature of the coil 210. In detail, the coil leveling step S224 includes a coil moving sub-step S2242 and a module moving sub-step S2244. The coil moving sub-step S2242 is for driving a first leveling module 310 of the leveling device 300 by the first rotating unit 330 to move the coil 210 in the X-axis direction. The module moving sub-step S2244 is for driving the second rotating unit 340 according to the simulated downward moving distance to move the second leveling module 320 of the leveling device 300 in the Z-axis direction.

The accuracy validating step S23 includes a curvature measuring step S232. The curvature measuring step S232 is for applying the curvature measuring device 400 to detect the coil 210 and obtain the second curvature of the coil 210. The second curvature is transmitted from the curvature measuring device 400 to the processor 500. In detail, the curvature measuring step S232 is for disposing a plurality of curvature detectors 410a, 410b, 410c at different positions of the platform 102, as shown in FIG. 1A. The curvature detectors 410a, 410b, 410c are spaced different distances from the inputting end 220 of the coil inputting device 200. The curvature detectors 410a, 410b, 410c are configured to detect a plurality of curvatures of the coil 210 at different positions and then output the curvatures to the processor 500.

The fault diagnosing step S24 is for applying the fault diagnosis device 700 to detect the coil inputting device 200, the leveling device 300 and the curvature measuring device 400 to generate a diagnostic message, and the diagnostic message is transmitted to the processor 500 by the fault diagnosis device 700. In detail, the fault diagnosing step S24 is for disposing a plurality of fault detectors 710a, 710b, 710c on the coil inputting device 200, the leveling device 300 and the curvature measuring device 400, respectively. Each of the fault detectors 710a, 710b, 710c is configured to detect whether or not the coil inputting device 200, the leveling device 300 or the curvature measuring device 400 is normal and generate a sensed message. The sensed message may represent a normal condition or a fault condition. The sensed message is transmitted to the processor 500, and the diagnostic message is composed of the sensed messages of the fault detectors 710a, 710b, 710c. Therefore, the fault diagnosis device 700 of the present disclosure can be monitored and feedback controlled via the cloud network in real time so as to ensure all machine settings and parameters meeting the target value and manufacturing quality.

The cloud information accessing step S25 is for applying the network server 800 to access the thickness M₁, the width M₂, the first curvature M₃, the simulated downward moving distance, the second curvature and the diagnostic message. The user interface 910 of the user terminal device 900 displays the thickness M₁, the width M₂, the first curvature M₃, the simulated downward moving distance, the second curvature and the diagnostic message. Moreover, the network server 800 stores an experience message and an internet message, and transmits the experience message and the internet message to the processor 500. Then, the processor 500 calculates the experience message, the internet message, the thickness M₁, the width M₂ and the first curvature M₃ to generate the simulated downward moving distance, thus realizing intelligent leveling and validation.

According to the aforementioned embodiments and examples, the advantages of the present disclosure are described as follows.

1. The system and method of the present disclosure can generate the optimal downward moving distances by performing the response surface equation with the thickness, the width and the first curvature of the coil, so that it is very suitable for the requirement of automatic intelligent production and measurement.

2. The system, and method of the present disclosure can utilize the real-time compensation to adjust the leveling device and accomplish the automatic intelligent real-time feedback control and validation.

3. The automatic fault diagnosis device of the present disclosure can be monitored and feedback controlled via the cloud network in real time so as to ensure all machine settings and parameters meeting the target value and manufacturing quality.

4. The system and method of the present disclosure can analyze the condition parameters of the devices by the network server combined with real-time continuous cloud monitoring and immediate visual information according to different customer requirements and specifications, so that the user can easily know whether there is any abnormality in the intelligent coil leveling validating system, and obtain quality and production efficiency of the coil in real time.

5. The system and method of the present disclosure can perform the optimal leveling process based on the integrated control of the CPS, digital experience information, IoT and big data.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An intelligent coil leveling validating system for leveling and validating a coil having a thickness, a width and a first curvature before leveling, the intelligent coil leveling validating system comprising:
a platform;
a coil inputting device disposed on the platform, wherein the coil inputting device comprising:
an inputting end; and
the coil movably connected to the inputting end;
a leveling device, wherein there is a first distance between the leveling device and the inputting end, and the leveling device comprises:
a first leveling module disposed on the platform and configured to move the coil; and
a second leveling module corresponding to the first leveling module and movably positioned on the platform, wherein the second leveling module has a practical downward moving distance, the coil is pressed and rolled by the first leveling module and the second leveling module, the coil is moved between the first leveling module and the second leveling module, and the coil has a second curvature;
a curvature measuring device disposed on the platform, wherein there is a second distance between the curvature measuring device and the inputting end, the second distance is greater than the first distance, the curvature measuring device detects the coil and obtains the second curvature; and
a processor signally connected to the leveling device and the curvature measuring device, wherein the processor calculates the thickness, the width and the first curvature to generate a simulated downward moving distance of the second leveling module according to a response surface method, the processor receives the second curvature and performs feedback control to adjust the practical downward moving distance close to the simulated downward moving distance.

2. The intelligent coil leveling validating system of claim 1, further comprising:
a network server signally connected to the processor, wherein the network server accesses the thickness, the width, the first curvature, the simulated downward moving distance and the second curvature; and
a user terminal device signally connected to the network server and having a user interface, wherein the user interface displays the thickness, the width, the first curvature, the simulated downward moving distance and the second curvature.

3. The intelligent coil leveling validating system of claim 1, wherein,
the coil moved along the first leveling module in a coil moving direction which is parallel to an X-axis direction; and
the second leveling module moved in a downward moving direction which is parallel to a Z-axis direction.

4. The intelligent coil leveling validating system of claim 1, wherein the leveling device further comprises:
a first rotating unit disposed on the platform and connected to the first leveling module, wherein the first rotating unit is controlled by the processor to rotate the first leveling module so as to move the coil in an X-axis direction; and
a second rotating unit disposed on the platform and connected to the second leveling module, wherein the second rotating unit is controlled by the processor to move the second leveling module in a Z-axis direction.

5. The intelligent coil leveling validating system of claim 1, further comprising:
a distance measuring device disposed on the platform and signally connected to the processor, wherein the distance measuring device detects the practical downward moving distance and transmits the practical downward moving distance to the processor.

6. The intelligent coil leveling validating system of claim 1, further comprising:
a fault diagnosis device disposed on the platform and signally connected to the coil inputting device, the leveling device, the curvature measuring device and the processor, wherein the fault diagnosis device detects the coil inputting device, the leveling device and the curvature measuring device to generate a diagnostic message, and the diagnostic message is transmitted to the processor by the fault diagnosis device.

7. The intelligent coil leveling validating system of claim 6, wherein the fault diagnosis device comprises:
a plurality of fault detectors disposed on the coil inputting device, the leveling device and the curvature measuring device, respectively, wherein the fault detectors are located at different positions relative to each other, each of the fault detectors is configured to detect whether or not the coil inputting device, the leveling device or the curvature measuring device is normal and generate a sensed message, the sensed message is transmitted to the processor, and the diagnostic message is composed of the sensed messages of the fault detectors.

8. The intelligent coil leveling validating system of claim 1, wherein the curvature measuring device comprises:
a plurality of curvature detectors disposed on the platform and signally connected to the processor, wherein the curvature detectors are spaced apart different distances from the inputting end, the curvature detectors are configured to detect a plurality of curvatures of the coil at different positions and output the curvatures to the processor.

9. The intelligent coil leveling validating system of claim 1, wherein the response surface method has a response surface equation which is given by:
Y=f(x_{R2},x_{R4},x_{R6}|M₁,M₂,M₃)+ε;
wherein Y represents a surface flatness of the coil, M₁ represents the thickness of the coil, M₂ represents the width of the coil, M₃ represents the first curvature of the coil, x_{R2} represents a first downward moving distance, x_{R4} represents a second downward moving distance, x_{R6} represents a third downward moving distance, and ε represents an error value.

10. A validating method of an intelligent coil leveling validating system for leveling and validating a coil, the validating method comprising:
providing a coil deformation analyzing step, wherein the coil deformation analyzing step is for analyzing a thickness, a width and a first curvature of the coil before leveling;
providing an intelligent leveling step, wherein the intelligent leveling step comprises:
providing a functional arithmetic processing step, wherein the functional arithmetic processing step is for applying a processor to calculate the thickness, the width and the first curvature according to a response surface method to generate a simulated downward moving distance of a second leveling module of a leveling device; and
providing a coil leveling step, wherein the coil leveling step is for applying the leveling device to press and roll the coil according to the simulated downward moving distance so as to deform the coil and generate a second curvature of the coil; and
providing an accuracy validating step, wherein the accuracy validating step is for applying a curvature measuring device to detect the coil and obtain the second curvature, and then the second curvature is transmitted from the curvature measuring device to the processor;
wherein the steps of the validating method are carried out in order of the coil deformation analyzing step, the intelligent leveling step and the accuracy validating step, the accuracy validating step is feedback connected to the intelligent leveling step, and the processor receives the second curvature and performs feedback control to adjust a practical downward moving distance of the second leveling module close to the simulated downward moving distance.

11. The validating method of the intelligent coil leveling validating system of claim 10, further comprising:
providing a fault diagnosing step, wherein the fault diagnosing step is for applying a fault diagnosis device to detect a coil inputting device, the leveling device and the curvature measuring device to generate a diagnostic message, and the diagnostic message is transmitted to the processor by the fault diagnosis device.

12. The validating method of the intelligent coil leveling validating system of claim 11, wherein the fault diagnosing step further comprising:
disposing a plurality of fault detectors on the coil inputting device, the leveling device and the curvature measuring device, respectively, wherein each of the fault detectors is configured to detect whether or not the coil inputting device, the leveling device or the curvature measuring device is normal and generate a sensed message, the sensed message is transmitted to the processor, and the diagnostic message is composed of the sensed messages of the fault detectors.

13. The validating method of the intelligent coil leveling validating system of claim 10, wherein the response surface method has a response surface equation which is given by:
Y=f(x_{R2},x_{R4},x_{R6}|M₁,M₂,M₃)+ε;
wherein Y represents a surface flatness of the coil, M₁ represents the thickness of the coil, M₂ represents the width of the coil, M₃ represents the first curvature of the coil, x_{R2} represents a first downward moving distance, x_{R4} represents a second downward moving distance, x_{R2} represents a third downward moving distance, and ε represents an error value.

14. The validating method of the intelligent coil leveling validating system of claim 10, wherein the coil leveling step comprising:
providing a coil moving sub-step, wherein the coil moving sub-step is for driving a first leveling module of the leveling device by a first rotating unit to move the coil in an X-axis direction; and
providing a module moving sub-step, wherein the module moving sub-step is for driving a second rotating unit according to the simulated downward moving distance to move the second leveling module of the leveling device in a Z-axis direction.

15. The validating method of the intelligent coil leveling validating system of claim 10, wherein the accuracy validating step comprising:
providing a curvature measuring step, wherein the curvature measuring step is for disposing a plurality of curvature detectors at different positions of a platform, the curvature detectors are spaced different distances from an inputting end of a coil inputting device, and the curvature detectors are configured to detect a plurality of curvatures of the coil at different positions and output the curvatures to the processor.

16. The validating method of the intelligent coil leveling validating system of claim 10, further comprising:
providing a cloud information accessing step, wherein the cloud information accessing step is for applying a network server to access the thickness, the width, the first curvature, the simulated downward moving distance and the second curvature, and a user interface of a user terminal device displays the thickness, the width, the first curvature, the simulated downward moving distance and the second curvature.

17. The validating method of the intelligent coil leveling validating system of claim 16, wherein the network server stores an experience message and an internet message, the network server transmits the experience message and the internet message to the processor, and then the processor calculates the experience message, the internet message, the thickness, the width and the first curvature to generate the simulated downward moving distance.
